(19) United States
(12) Patent Application Publication
(10) Pub. No.: US 2025/0143846 A1
(43) Pub. Date: May 8, 2025

(54) DENTAL IMPLANTS, DENTAL ASSEMBLIES, AND METHODS OF IMPLANTING AND REPAIRING DENTAL ASSEMBLIES

(71) Applicant: The Trustees of Indiana University, Bloomington, IN (US)

(72) Inventor: Thomas R. Katona, Indianapolis, IN (US)

(21) Appl. No.: 18/913,249

(22) Filed: Oct. 11, 2024

Related U.S. Application Data
(60) Provisional application No. 63/597,096, filed on Nov. 8, 2023.

(51) Int. Cl. A61C 8/00

(52) U.S. Cl. CPC A61C 8/0025; A61C 8/0089

(57) ABSTRACT

Dental restorations utilizing dental implants and abutments that can be secured together using a bi-directional thread feature, and methods relating thereto. The dental implants include a body having a longitudinal length, external threads along the longitudinal length, and a longitudinal bore within the body. A first internal thread set of right-hand threads is within the longitudinal bore and configured to threadably engage a right-hand threaded fastener, and a second internal thread set of left-hand threads is within the longitudinal bore, integrated with the first internal thread set, and configured to threadably engage a left-hand threaded fastener.

### CROSS-REFERENCE TO RELATED APPLICATIONS

This application claims the benefit of provisional U.S. Patent Application No. 63/597,096 filed Nov. 8, 2023, the contents of which are incorporated herein by reference.

### BACKGROUND OF THE INVENTION

The present invention generally relates to dental implants, dental assemblies, dental restorations, and methods and kits relating thereto.

When an individual loses a tooth due to injury, disease, or other cause, a dental assembly, sometimes referred to as a dental restoration, may be placed in the individual's jaw as a replacement for the lost tooth to restore the individual's ability to chew and/or to enhance their appearance. As schematically represented in FIGS. 1 through 3, a conventional single-crown dental restoration 10 generally includes a dental implant 12, an abutment 16, and a dental prosthesis (e.g., crown) 24. The implant 12 includes a body 14 represented as tapered to have a larger diameter at an upper end 17 thereof and a smaller diameter at a lower end 19 thereof. External threads 15 are formed along the longitudinal length of the implant body 14, generally between the upper and lower ends 17 and 19 thereof. The implant 12 further includes a head 13 shown as cylindrically shaped and configured to accept the abutment 16, such as by inserting a lower portion 18 of the abutment 16 into an internal bore (not shown) within the head 13 of the implant 12. The abutment 16 is depicted as having an upper portion 20 that is frustoconically shaped, tapering so that the widest portion of the upper portion 20 is adjacent the lower portion 18 of the abutment 16. The crown 24 is secured to the upper portion 20 of the abutment 16 and typically held in place with a dental cement.

In FIG. 1, the abutment 16 is represented as secured to the implant 12 with a threaded fastener 22 (commonly referred to as an abutment screw) whose external threads engage internal threads within the implant 12. The threads of the fastener 22 and implant 12 are typically right-hand threads, meaning that the fastener 22 is rotated clockwise to thread the fastener 22 into the implant 12. FIG. 2 depicts an example of a dental restoration 10 in which the fastener 22 is integrally-formed on the lower portion 18 of the abutment 16. FIG. 2 also represents the crown 24 as having an opening 26 at a lower end 28 thereof that is configured to engage the upper portion 20 of the abutment 16.

FIG. 3 schematically represents an installation procedure for dental restorations 10 of the types represented in FIGS. 1 and 2. In the procedure, an implant hole 36 is created in the jawbone 30 of a patient, after which the implant 12 is threaded through the gum 32 and into the implant hole 36 utilizing the external threads 15 on the body 14 of the implant 12 to grip the jawbone 30 and secure the implant 12. The implant 12 is shown implanted in the jawbone 30 so that the head 13 of the implant 12 is substantially flush with the surface of the gums 32. The abutment 16 is then seated with the lower portion 18 thereof within the internal bore (not shown) of the implant 12. In the procedure represented in FIG. 3, the abutment 16 is generally configured as represented in FIG. 2 to be used in combination with the separate fastener 22 (not shown) of FIG. 2, which passes through the abutment 16 and is threaded into the implant 12 to secure the abutment 16 to the implant 12. Thereafter, the crown 24 is affixed to the upper portion 20 of the abutment 16.

Dental restorations are placed in complex environments that experience several different loads imposed upon the implant. For example, transient forces are imposed on implants when an individual chews, chomps down, and clenches their jaw. The direction and magnitude of these forces can vary depending upon the location of the implant in the patient's jaw. These forces, along with other factors, may result in the implant failing, as a nonlimiting example, due to the loosening of the abutment's threaded connection with the implant, which is the most common cause of clinical failures of threaded dental restorations. The direction of the forces can be such that they cause the abutment to rotate counterclockwise, thereby causing the abutment to loosen when secured to an implant with right-hand threads. Likewise, the direction of the forces on the abutment can be such that they cause the abutment to rotate clockwise, thereby causing the abutment to loosen if placed in an implant using left-hand threads.

In view of the above, it would be desirable if dental implants and repair methods were available that were capable of at least partly overcoming or avoiding the problems, shortcomings or disadvantages noted above.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, dental implants, dental assemblies, dental restorations, and methods relating thereto.

According to a nonlimiting aspect of the invention, a dental implant for implantation into a patient's jawbone includes a body having a longitudinal length, external threads along the longitudinal length, and a longitudinal bore within the body. Bi-directional internal threads within the longitudinal bore are configured to alternatively threadably engage a right-hand threaded fastener and threadably engage a left-hand threaded fastener.

According to another nonlimiting aspect of the invention, a dental assembly includes a dental implant as described above and an abutment assembled thereto. The abutment has associated therewith right-hand external threads threadably engaged with the bi-directional internal threads of the dental implant to secure the abutment to the dental implant, or has associated therewith left-hand external threads threadably engaged with the bi-directional internal threads of the dental implant to secure the abutment to the dental implant. A dental restoration can be provided by assembling a crown to the abutment of the dental assembly.

Other nonlimiting aspects of the invention include methods of utilizing dental implants and dental assemblies as described above to install and/or repair a dental restoration. For example, a dental restoration can be installed by drilling an implant hole in a jawbone of a patient, implanting the dental implant into the implant hole so that the external threads of the dental implant secure the dental implant within the implant hole, placing an abutment on the dental implant, and then threading a first fastener into the bi-directional internal threads within the longitudinal bore of the dental implant to secure the abutment to the dental implant. The first fastener may have either right-hand external threads or left-hand external threads. A dental restoration installed in this manner can be repaired by removing the first fastener from the longitudinal bore of the dental implant, and then threading a second fastener into the bi-directional internal threads within the longitudinal bore of the dental implant to secure the abutment to the dental implant. The second fastener may have either right-hand external threads or left-hand external threads.

Technical aspects of dental restorations, implants, assemblies, and methods as described above preferably include the ability to accommodate both right-hand threads and left-hand threads associated with abutments to counteract the clockwise and counterclockwise rotational forces on abutments that can lead to loosening and failure.

Other aspects and advantages will be appreciated from the following detailed description as well as any drawings.

### BRIEF DESCRIPTION OF THE SEVERAL VIEWS OF THE FIGURES

FIGS. 1 and 2 schematically represent side cross-sectional views of conventional dental restorations and components thereof.

FIG. 3 schematically represents an implantation procedure performed with a dental restoration similar to that of FIG. 1.

FIG. 4 schematically represents a longitudinal cross-sectional view of a dental implant for a dental restoration in accordance with a nonlimiting embodiment of the present invention.

FIGS. 5 and 6 schematically represent side views of, respectively, a right-hand threaded fastener and a left-hand threaded fastener capable of use with the implant of FIG. 4.

FIG. 7 schematically represents a longitudinal cross-sectional view of the implant of FIG. 4 and the fastener of FIG. 5 securing an abutment to the implant.

FIG. 8 schematically represents a longitudinal cross-sectional view of the implant of FIG. 4 and the fastener of FIG. 6 securing an abutment to the implant.

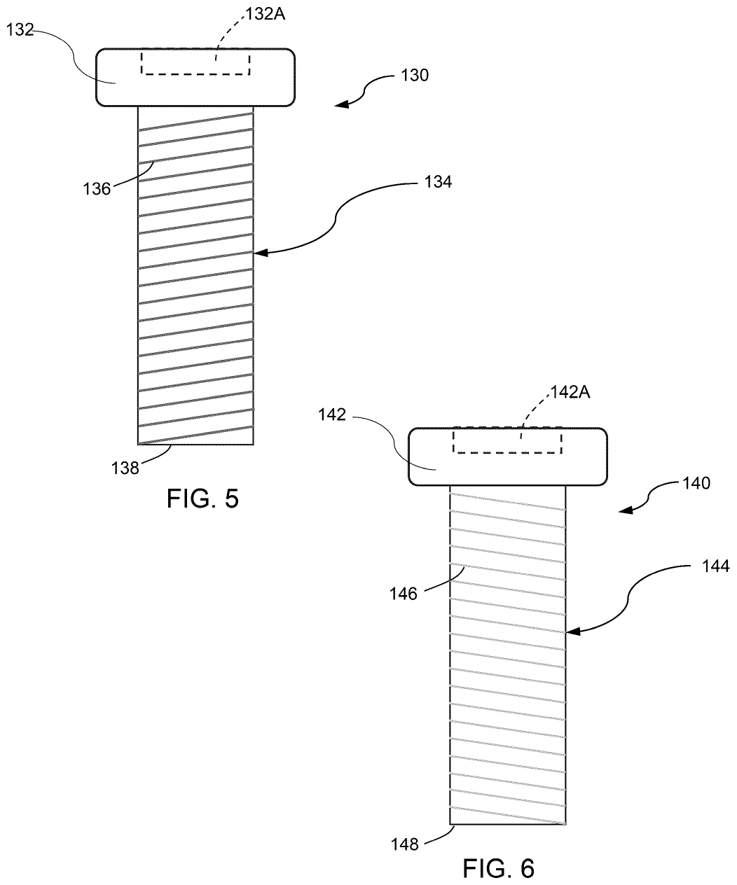

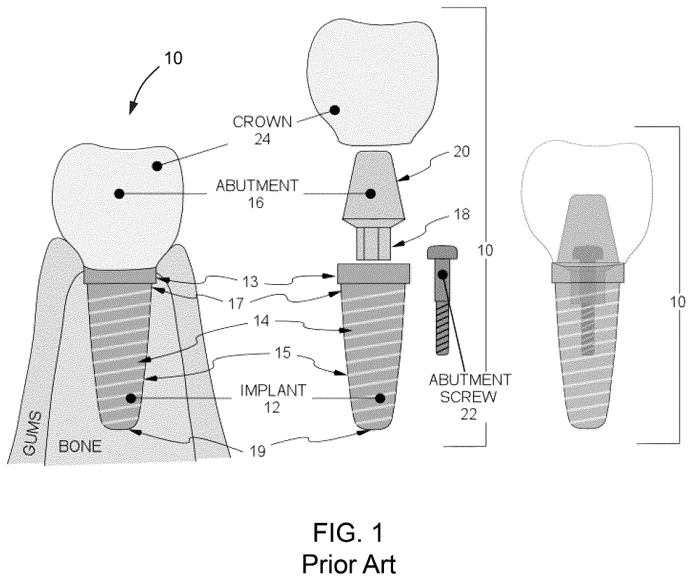

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

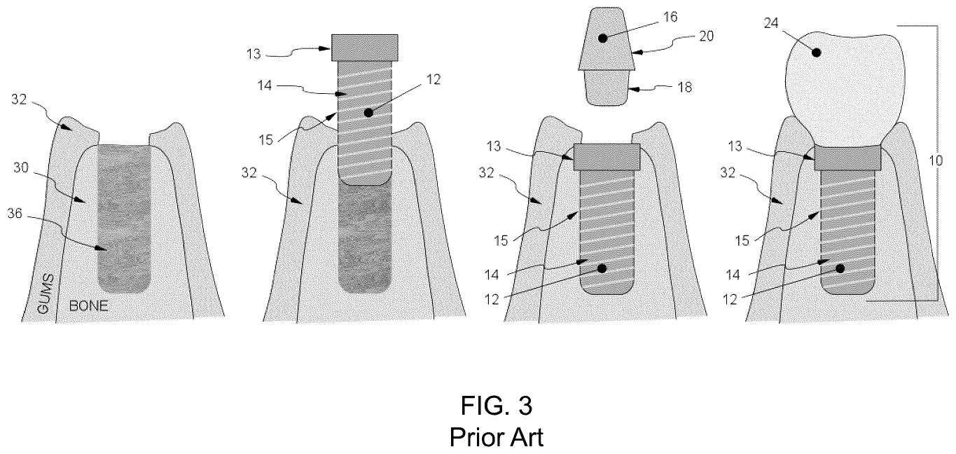

The following disclosure describes various aspects of nonlimiting embodiments of dental restorations, dental implants, abutments, and methods relating to their use are schematically represented in FIGS. 4 through 8. To facilitate the description provided below of the embodiments represented in the drawings, relative terms, including but not limited to, “proximal,” “distal,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientations of components represented in the drawings, which represent dental restorations in the lower jaw (mandible) that are equally applicable to dental restorations in the upper jaw (maxilla). Therefore, all such relative terms are intended to indicate the construction and relative locations of the components and features of the dental restorations relative to each other and therefore are useful to describe the illustrated embodiments and indicate the construction, installation, and use of the dental restorations, but otherwise do not limit the scope of the invention. Furthermore, the invention is generally applicable to all implant-supported prostheses that include a threaded component, a particular but nonlimiting example of which is a single-crown prosthesis shown in the drawings.

FIG. 4 schematically represents a dental implant 112 as including a body 114 having a longitudinal length, an upper end 117, and a lower end 119. The body 114 is represented as generally tapered or frustoconically shaped to have a widest portion at the upper end 117 and narrowing toward the lower end 119. External threads 115 are formed on the body 114 between the upper and lower ends 117 and 119 of the body 114. The external threads 115 may, for example, begin at or near the lower end 119 and extend part way up the body 114, as shown in FIG. 4, or extend along the entirety of the body to the upper end 117. The external threads 115 are of a type capable of securing the implant 112 to a patient's jawbone. A longitudinal blind bore 114A is defined within the body 114 and extends from the upper end 117 of the body 114 in a longitudinal direction of the body 114 toward but not through the lower end 119 of the body 114 so that a lower end 114B of the bore 114A terminates in proximity to the lower end 119 of the implant 112.

The bore 114A is represented as being generally cylindrically shaped, though other shapes are foreseeable. A set of bi-directional internal threads 123 is disposed along a sidewall of the bore 114A and extends generally axially from an open end of the bore 114A at the upper end 117 of the body 114 toward and preferably to the lower end 114A of the bore 114A. The bi-directional internal threads 123 are configured to alternatively receive and threadably engage both right-hand threaded fasteners and left-hand threaded fasteners. In this non-limiting example, the bi-directional internal threads 123 include two sets of internal (female) threads 123A and 123B formed on the sidewall of the bore 114A. The first internal thread set 123A forms right-hand threads that extend along the longitudinal length of the bore 114A, and the second internal thread set 123B forms left-hand threads that also extend along the longitudinal length of the bore 114A, so that the first and second internal thread sets 123A and 123B are at least partially and optionally, as shown in FIG. 4, entirely superimposed on each other between the upper end 117 of the implant 112 and the lower end 114B of its bore 114A so as to be integrated with each other, resulting in the bore 114A having a bi-directional thread feature.

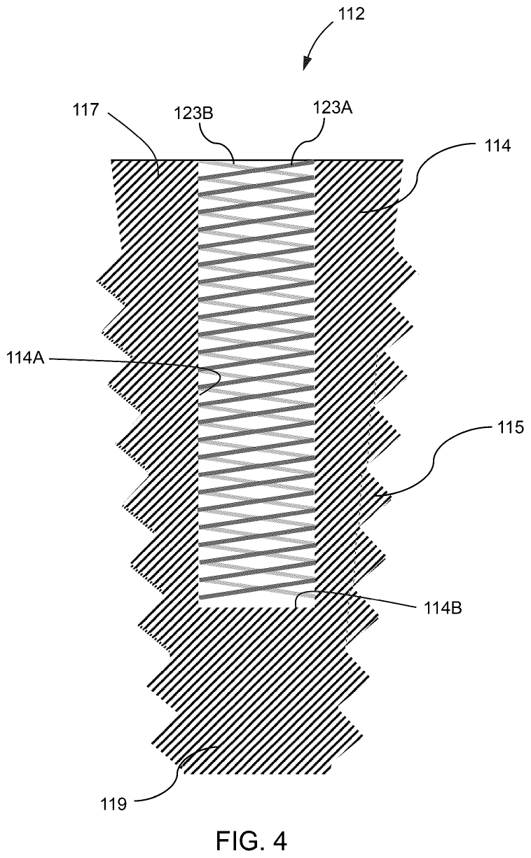

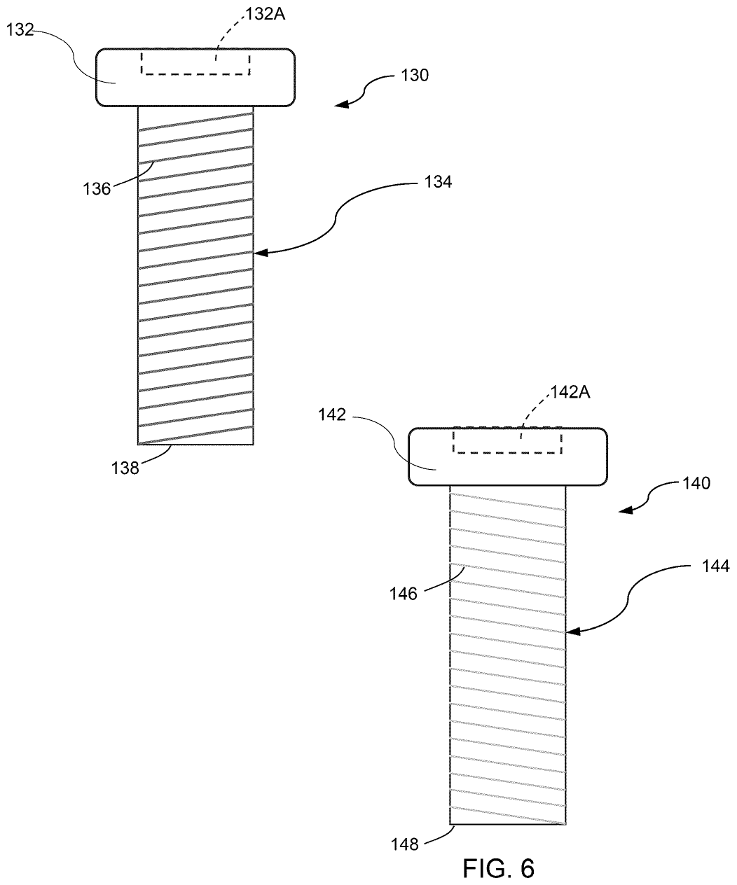

FIGS. 5 and 6 schematically represent threaded fasteners 130 and 140, respectively, that are configured to individually threadably engage one of the first and second internal thread sets 123A and 123B of the implant 112 of FIG. 4, such that the fasteners 130 and 140 are interchangeable for assembly with the implant 112. The fasteners 130 and 140 are generally configured as screws or bolts and may be of the types commonly referred to as abutment screws used with dental prostheses, though other forms of threaded fasteners are foreseeable. The fastener 130 of FIG. 5 includes a head 132 and a threaded shank 134 along whose length external (male) threads 136 are formed between the head 132 of the fastener 130 to a lower end 138 of the shank 134. Similarly, FIG. 6 represents the fastener 140 as including a head 142 and a threaded shank 144 along whose length external (male) threads 146 are formed between the head 142 of the fastener 140 to a lower end 148 of the shank 144. The threads 136 and 146 of the fasteners 130 and 140 are respectively right-hand and left-hand threads and as such the fasteners 130 and 140 may be referred to as a right-hand threaded fastener 130 and a left-hand threaded fastener 140, respectively, or more simply a right-hand fastener 130 and a left-hand fastener 140. It should be noted that, though not commonly used, left-hand threads such as those of the fastener 140 are mechanically equivalent to far more common right-hand threads such as those of the fastener 130.

To facilitate the ability of a user to quickly distinguish the fasteners 130 and 140 in a clinical setting, the heads 132 and 142 of the fasteners 130 and 140 may be equipped to be driven by different driving tools, for example, the head 132 of the fastener 130 may have a socket, slot, or other feature 132A adapted for coupling with one type of driver, e.g., an Allen socket, a standard screwdriver slot, Philips screwdriver slot, star screwdriver (e.g., Torx®), etc., whereas the head 142 of the fastener 140 may have a socket, slot, or other feature 142A adapted for coupling with a different type of driver.

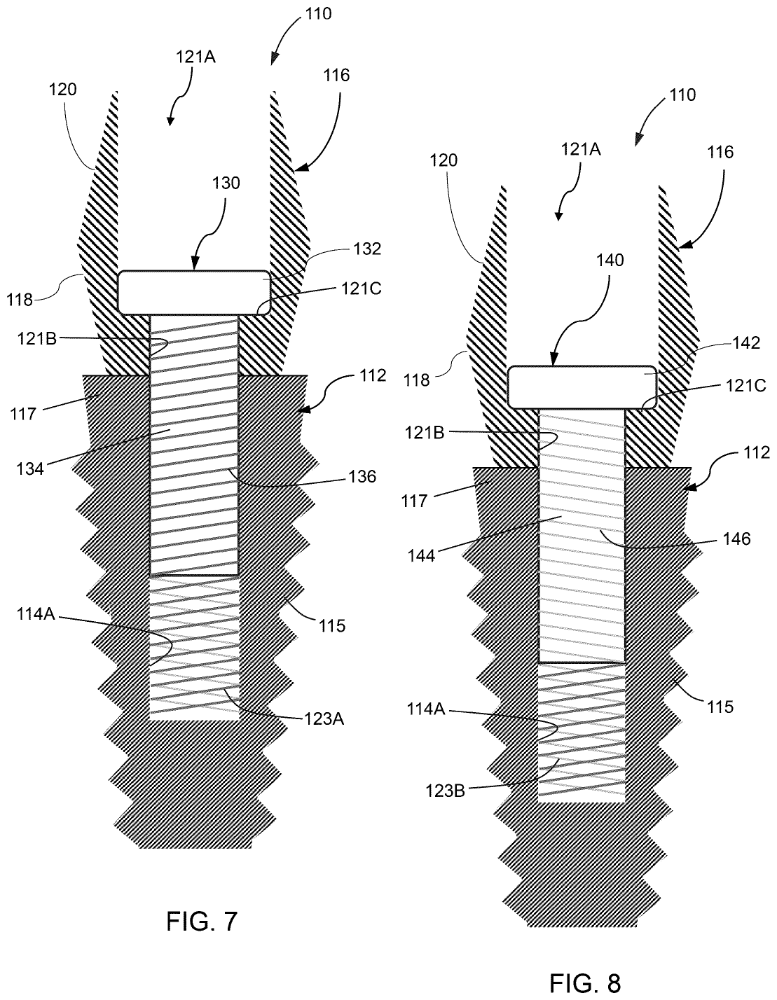

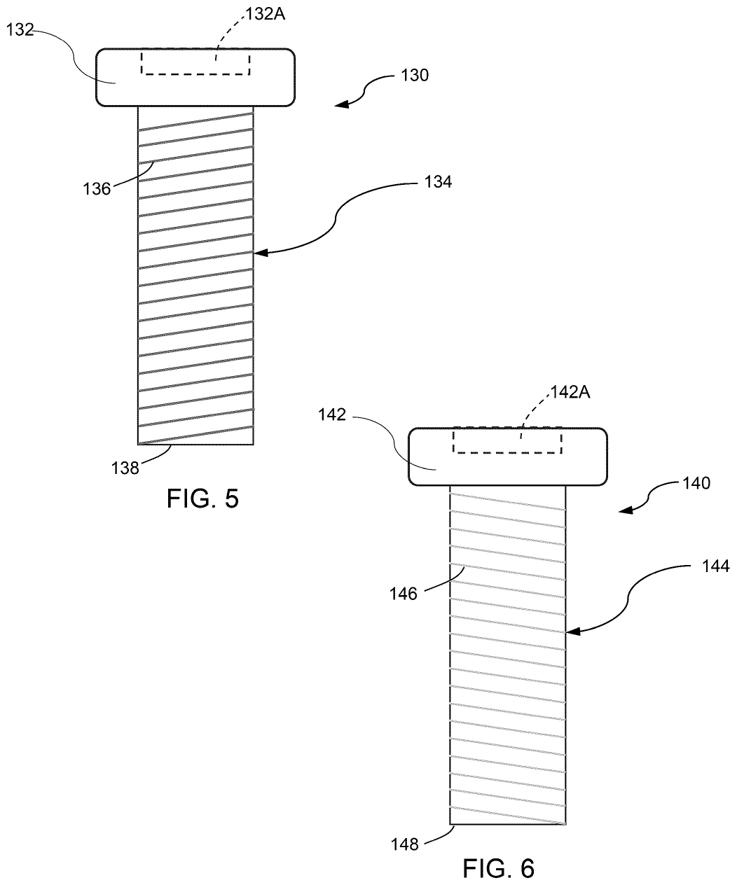

FIGS. 7 and 8 schematically represent dental assemblies 110 utilizing the implant 112 of FIG. 4 and the fasteners 130 and 140 of FIGS. 5 and 6 to secure an abutment 116 to the implant 112. FIG. 7 depicts the implant 112 and abutment 116 being fastened together with the right-hand fastener 130 of FIG. 5, and FIG. 8 depicts the implant 112 and abutment 116 being fastened together with the left-hand fastener 140 of FIG. 6. Though the fasteners 130 and 140 are represented in the drawings as being separate components of the abutment 116, it is foreseeable that different abutments 116 could be utilized in the assemblies 110, with the abutment 116 of FIG. 7 having the fastener 130 (or the right-hand threads 136) integrally formed and extending from a lower portion 118 thereof and the abutment 116 of FIG. 8 having the fastener 140 (or the left-hand threads 146) integrally formed and extending from the lower portion 118 thereof. The exemplary abutments 116 of FIGS. 7 and 8 are each further represented as having an upper portion 120 oppositely disposed from their respective lower portion 118. The lower portion 118 and upper portion 120 are each represented as conically shaped, with their largest widths being directly adjacent to each other. The abutment 116 further includes a bore 121A and a through-hole 121B that are each configured to interchangeably accept both of the fasteners 130 and 140. The bore 121A is sized and configured to accept the heads 132 and 142 of the fasteners 130 and 140, and the through-hole 121A is sized and configured to accept the shanks 134 and 144 of the fasteners 130 and 140. The bore 121A has a larger radial dimension, such as a diameter, than the through-hole 121B, thereby forming an annular radial shoulder at a lower end 121C of the bore 121A. For both fasteners 130 and 140, the heads 132 and 142 contact the lower end 121C of the bore 121A to clamp and secure the abutment 116 to the implant 112. In FIG. 7, the threads 136 of the right-hand fastener 130 are engaged with the right-hand threads 123A of the implant 112 to secure the abutment 116 to the implant 112, and in FIG. 8 the threads 146 of the left-hand fastener 140 are engaged with the left-hand threads 123B of the implant 112 to secure the abutment 116 to the implant 112. As such, in addition to being interchangeable for assembly with the implant 112, the fasteners 130 and 140 are also interchangeable for assembly with the abutment 116.

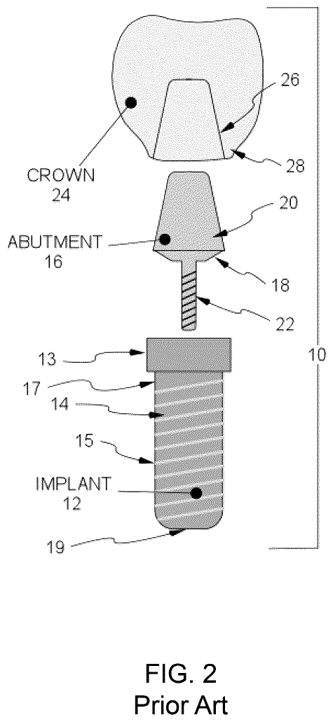

The implant 112 is configured to aid in rectifying what may be referred to as a failed dental restoration, as a nonlimiting example, an abutment 116 whose threaded connection with the implant 112 has loosened. Similar to what was described in reference to FIG. 3, the implant 112 can be implanted in a patient's jawbone by drilling an implant hole in the jawbone and then threading the lower end 119 of the implant 112 into the implant hole utilizing the external threads 115 of the implant 112. The abutment 116 is placed on the upper end 117 of the implanted implant 112 so that the lower portion 118 of the abutment 116 abuts the upper end 117 of the implant 112 and the bore 121A and through-hole 121B of the abutment 116 are aligned with the threaded bore 114A of the implant 112. The shank 134 or 144 of the right-hand fastener 130 or left-hand fastener 140 can then be inserted through the hole 121B of the abutment 116 and threaded into the threaded bore 114A of the implant 112 to yield the respective dental assembly 110 shown in FIG. 7 or 8. Due to having right-hand threads 136, the right-hand fastener 130 threadably engages the first internal thread set 123A of right-hand threads within the bore 114A of the implant 112, whereas if the left-hand fastener 140 is used the left-hand threads 146 thereof cause the fastener 140 to threadably engage the second internal thread set 123B of left-hand threads within the bore 114A. Thereafter, a crown (not shown) can be secured to the upper portion 120 of the abutment 116 in any suitable manner, such as with a dental cement, to complete the installation of the dental restoration.

Once the dental restoration is installed, forces in the patient's mouth may cause the fastener 130 or 140 (depending on which is installed) to rotate clockwise or counterclockwise and loosen. The fastener 130 or 140 may be removed from the implant 112 and, due to the presence of the bi-directional threads 123A and 123B within the implant bore 114A, the other fastener 140 or 130 may be installed in its place. If the right-hand fastener 130 was originally installed and the tendency for prevailing counterclockwise forces caused the fastener 130 to loosen, replacing the fastener 130 with the left-hand fastener 140 results in an assembly 110 that resists loosening because the counterclockwise forces cause the left-hand fastener 140 to tighten, and not loosen, within the implant bore 114. On the other hand, if the left-hand fastener 140 was originally installed and the tendency for prevailing clockwise forces caused the fastener 140 to loosen, replacing the fastener 140 with the right-hand fastener 130 results in an assembly 110 that resists loosening because the prevailing clockwise forces cause the right-hand fastener 130 to tighten, and not loosen, within the implant bore 114. As such, the dental restoration can be modified or repaired without requiring the replacement of the implant 112 or abutment 116.

The ability to thread either the right-hand or left-hand fastener 130 or 140 into the bore 114A of the implant 112 also offers the possibility of replacing the installed fastener 130 or 140 with the other fastener 140 or 130 in the event of damage to the threads 136 or 146 of the fastener 130 or 140 and/or damage to one set of the threads 123A or 123B of the implant 112. The original and repair procedures described above may be facilitated through the use of a kit, as a nonlimiting example, a kit that contains two fasteners 130 and 140 (both right-hand and left-hand), two different drivers adapted for coupling with different coupling features 132A and 142A of the fasteners 130 and 140, and optionally thread chasers for repairing any damage to the threads 123A or 123B of the implant 112.

As previously noted above, though the foregoing detailed description describes certain aspects of one or more particular embodiments of the invention, alternatives could be adopted by one skilled in the art. For example, a dental restoration, implant, abutment, and/or fastener could differ in appearance from the embodiments described herein and shown in the drawings, and functions of certain components of the dental restorations could be performed by components of different construction but capable of a similar (though not necessarily equivalent) function. As such, and again as was previously noted, it should be understood that the invention is not necessarily limited to any particular embodiment described herein or illustrated in the drawings.

1. A dental implant for implantation into a patient's jawbone, the dental implant comprising:
a body having a longitudinal length, external threads along the longitudinal length, and a longitudinal bore within the body; and
bi-directional internal threads within the longitudinal bore, wherein the bi-directional threads are configured to alternatively threadably engage a right-hand threaded fastener and threadably engage a left-hand threaded fastener.

2. The dental implant of claim 1, wherein the bi-directional internal threads comprise:
a first internal thread set of right-hand threads within the longitudinal bore, the first internal thread set being configured to threadably engage the right-hand threaded fastener; and
a second internal thread set of left-hand threads within the longitudinal bore and integrated with the first internal thread set, the second internal thread set being configured to threadably engage the left-hand threaded fastener.

3. A dental assembly comprising:
the dental implant of claim 1; and
an abutment assembled thereto, the abutment having associated therewith right-hand external threads threadably engaged with the bi-directional internal threads of the dental implant to secure the abutment to the dental implant or having associated therewith left-hand external threads threadably engaged with the bi-directional internal threads of the dental implant to secure the abutment to the dental implant.

4. The dental assembly of claim 3, further comprising a fastener that is assembled with the abutment to provide the abutment with the right-hand external threads or with the left-hand external threads associated therewith.

5. The dental assembly of claim 4, wherein the fastener is a first threaded fastener having the right-hand external threads thereon, the dental assembly further comprising a second threaded fastener having the left-hand external threads thereon, the first and second threaded fasteners being interchangeable for assembly with the bi-directional internal threads of the dental implant.

6. The dental assembly of claim 5, wherein the first and second threaded fasteners are also interchangeable for assembly with the abutment.

7. The dental assembly of claim 5, wherein the first and second fasteners have different coupling features for coupling with different drivers.

8. A dental restoration comprising:
the dental assembly of claim 3; and
a crown assembled thereto, the abutment having a first portion secured to the bi-directional internal threads of the dental implant, the abutment having a second portion to which the crown is attached.

9. A method of installing a dental restoration, the method comprising:
drilling an implant hole in a jawbone of a patient;
implanting the dental implant of claim 1 into the implant hole so that the external threads of the dental implant secure the dental implant within the implant hole;
placing an abutment on the dental implant; and
threading a first fastener into the bi-directional internal threads within the longitudinal bore of the dental implant to secure the abutment to the dental implant, the first fastener comprising either right-hand external threads or left-hand external threads.

10. The method of claim 9, wherein the first fastener comprises the right-hand external threads.

11. The method of claim 9, wherein the first fastener comprises the left-hand external threads.

12. A method of repairing the dental restoration of claim 8 after the dental restoration was installed according to the method of claim 8, the method comprising:
removing the first fastener from the longitudinal bore of the dental implant; and
threading a second fastener into the bi-directional internal threads within the longitudinal bore of the dental implant to secure the abutment to the dental implant, the second fastener comprising either right-hand external threads or left-hand external threads.

13. The method of claim 12, wherein the first fastener comprises the right-hand external threads and the second fastener comprises the left-hand external threads.

14. The method of claim 12, wherein the first fastener comprises the left-hand external threads and the second fastener comprises the right-hand external threads.

15. A kit for use in the method of claim 12, wherein the first fastener has either the right-hand external threads or the left-hand external threads thereon, and the second fastener has either the right-hand external threads or the left-hand external threads thereon that are oppositely threaded to the first fastener.

16. The kit of claim 15, further comprising two different drivers adapted for coupling with different coupling features of the first and second fasteners.

17. The kit of claim 15, further comprising thread chasers for repairing any damage to the first and/or second internal thread sets within the longitudinal bore of the dental implant.
